(19) United States
(12) Patent Application Publication
(10) Pub. No.: US 2026/0365524 A1
(43) Pub. Date: Nov. 19, 2026

(54) METHOD OF PROCESSING A BODY OF POLYCRYSTALLINE DIAMOND MATERIAL

(71) Applicant: Element Six (UK) Limited, Didcot, Oxfordshire (GB)

(72) Inventors: David Thomas FORD, Harwell, Oxfordshire (GB); David William ALDMINGTON, Harwell, Oxfordshire (GB); Carmen Elena ZVORISTE-WALTERS, Harwell, Oxfordshire (GB); Jonathan James BIDDULPH, Harwell, Oxfordshire (GB)

(21) Appl. No.: 19/143,786

(22) PCT Filed: Dec. 22, 2023
(86) PCT No.: PCT/EP2023/087601

§ 371 Date: Jun. 26, 2025

(30) Foreign Application Priority Data
Dec. 31, 2022 (GB) 2219869.1
Dec. 31, 2022 (GB) 2219870.9
Dec. 31, 2022 (GB) 2219871.7
Dec. 31, 2022 (GB) 2219872.5
Dec. 31, 2022 (GB) 2219873.3
Dec. 31, 2022 (GB) 2219875.8
Dec. 31, 2022 (GB) 2219876.6
Dec. 31, 2022 (GB) 2219877.4
Dec. 31, 2022 (GB) 2219878.2
Dec. 31, 2022 (GB) 2219879.0
Dec. 31, 2022 (GB) 2219880.8
Dec. 31, 2022 (GB) 2219881.6
Dec. 31, 2022 (GB) 2219882.4

(51) Int. Cl. C01B 32/28; B01D 11/02

(52) U.S. Cl. CPC C01B 32/28; B01D 11/0288

(57) ABSTRACT

A method for leaching a polycrystalline diamond (PCD) cutter element includes providing a leaching receptacle having an interior volume, introducing a volume of liquid acid leaching mixture into the leaching receptacle, the volume being between around 5% to around 80% of the interior volume of the leaching receptacle, attaching the PCD cutter element to a fixture, applying a seal member around the PCD cutter element, locating the fixture with the PCD cutter element attached in the leaching receptacle to suspend the PCD cutter element above the acid leaching mixture, sealing the leaching receptacle to provide a closed system, elevating the temperature of the liquid acid leaching mixture to above ambient conditions to transition at least some of the liquid acid leaching mixture to acid vapour(s), and exposing the PCD cutter element to the acid vapour(s) to leach the PCD cutter element.

This disclosure relates to a method of processing a body of polycrystalline diamond (PCD) material and a PCD construction so processed.

### BACKGROUND

Cutter inserts for machining and other tools may typically comprise a layer of polycrystalline diamond (PCD) material bonded to a cemented carbide substrate. PCD is an example of a superhard material, also called a superabrasive material, which has a hardness value substantially greater than that of cemented tungsten carbide.

Components comprising PCD are used in a wide variety of tools for cutting, machining, drilling or degrading hard or abrasive materials such as rock, metal, ceramics, composites and wood-containing materials. PCD comprises a mass of substantially inter-grown (inter-bonded) diamond grains forming a skeletal mass, which define interstices between the diamond grains. PCD material typically comprises at least about 80 volume % of diamond and may be made by subjecting an aggregated mass of diamond grains to an ultra-high pressure of greater than about 5 GPa, typically about 5.5 GPa or more, and temperature of at least about 1200 °C, typically about 1440 °C, in the presence of a sintering aid, also referred to as a solvent catalyst material for diamond. Solvent catalyst materials for diamond are understood to be materials capable of promoting direct inter-growth of diamond grains at a pressure and temperature condition at which diamond is thermodynamically more stable than graphite.

Examples of solvent catalyst materials for diamond are cobalt, iron, nickel and certain alloys including alloys of any of these elements. PCD may be formed, for example, on a cobalt-cemented tungsten carbide substrate, which may provide a source of cobalt catalyst material for the PCD. During sintering of the body of PCD material, a constituent of the cemented carbide substrate, such as cobalt from a cobalt cemented tungsten carbide substrate, liquefies and sweeps from a region adjacent the volume of diamond particles into interstitial regions between the diamond particles. In this example, the cobalt acts as a solvent catalyst to facilitate the formation of bonded diamond grains. Optionally, a metal-solvent catalyst may be mixed with diamond particles prior to subjecting the diamond particles and substrate to the HPHT process. The interstices within PCD material may at least partly be filled with the solvent catalyst material. The intergrown (inter-bonded) diamond structure therefore comprises original diamond grains as well as a newly precipitated or re-grown diamond phase, which bridges the original grains. In the final sintered structure, catalyst/solvent material generally remains present within at least some of the interstices that exist between the sintered diamond grains.

Sintered PCD typically has sufficient wear resistance and hardness for use in aggressive wear, cutting and drilling applications however a well-known problem experienced with this type of PCD compact or cutting element is that the presence of residual solvent catalyst material in the microstructural interstices may have a detrimental effect on the performance of the PCD compact at high temperatures as it is believed that the presence of the solvent catalyst in the diamond table reduces the thermal stability of the diamond table at these elevated temperatures. For example, the difference in thermal expansion coefficient between the diamond grains and the residual solvent/catalyst is believed to lead to chipping or cracking in the PCD table of a cutting element during drilling or cutting operations where operating temperatures may reach 700 degrees C or more. The chipping or cracking in the PCD material may degrade the mechanical properties of the cutting element or lead to failure of the cutting element. Additionally, at high temperatures, diamond grains may undergo a chemical breakdown or back-conversion with the solvent catalyst. At extremely high temperatures, portions of diamond grains may transform to carbon monoxide, carbon dioxide, graphite, or combinations thereof, thereby degrading the mechanical properties of the PCD material.

A potential solution to these problems is to remove residual solvent catalyst (also known as binder phase) from the PCD material.

Chemical leaching is often used to remove metal solvent catalyst, such as cobalt, from interstitial regions of a body of PCD material, for example from regions adjacent the working surfaces of the PCD. It is typically extremely difficult and time consuming to remove effectively the bulk of a metallic solvent catalyst from a PCD table, particularly from the thicker PCD tables required by current applications. In general, current art is focused on achieving PCD of high diamond density and commensurately PCD that has an extremely fine distribution of metal solvent catalyst pools. This fine network typically resists penetration by the leaching agents, such that residual solvent catalyst often remains behind in the leached compact. Furthermore, achieving appreciable leaching depths can take so long as to be commercially unfeasible or require undesirable interventions such as extreme acid treatment or physical drilling of the PCD tables.

A common approach for removing the catalyst from a PCD material is to leach the PCD material to remove some or substantially all the interstitial catalyst from the PCD lattice structure, thereby transforming the PCD material into a more thermally stable polycrystalline diamond material. Leaching typically involves placing the cutter element in a strong acid bath at an elevated temperature to expose the PCD table to the acid. Typical suitable acids for leaching include nitric acid, sulfuric acid, hydrofluoric acid, hydrochloric acid, and combinations thereof. Although such leaching acids can aid in removing the catalyst from the PCD material, they can also damage the underlying substrate to which the PCD table is secured and appropriate sealing is required to protect the substrate from such damage. Conventional leaching techniques using an acid bath are relatively time-consuming and it may take days or weeks to remove a sufficient quantity of the residual solvent catalyst from the PCD material. This increases the overall time, and associated costs, to manufacture cutter elements and fixed cutter drill bits into which such cutters are located in use.

There is therefore a need to overcome or substantially ameliorate the above-mentioned problems through a technique for treating or processing a body of PCD material.

### SUMMARY

Viewed from a first aspect there is provided a method for leaching a polycrystalline diamond (PCD) cutter element having a non-diamond phase comprising a solvent catalyst material, the method comprising:
(a) providing a leaching receptacle having an interior volume;
(b) introducing a volume of liquid acid leaching mixture into the leaching receptacle, the volume being between around 5% to around 80% of the interior volume of the leaching receptacle;
(c) attaching the PCD cutter element to a fixture;
(d) applying a seal member around the PCD cutter element;
(d) locating the fixture with the PCD cutter element attached in the leaching receptacle to suspend the PCD cutter element above the acid leaching mixture;
(e) sealing the leaching receptacle to provide a closed system;
(f) elevating the temperature of the liquid acid leaching mixture to above ambient conditions to transition at least some of the liquid acid leaching mixture to acid vapour(s); and
(g) exposing the PCD cutter element to the acid vapour(s) to leach the PCD cutter element.

Viewed from a second aspect there is provided a polycrystalline diamond construction treated according to the above-defined method to remove residual solvent catalyst material from at least a portion of interstitial spaces between interbonded diamond grains.

### BRIEF DESCRIPTION OF THE DRAWINGS

Various versions will now be described in more detail, by way of example, with reference to the accompanying figures in which:

FIG. 1 is a schematic perspective view of a PCD cutter insert for a cutting drill bit for boring into the earth;

FIG. 2 is a schematic cross section view of a portion of the PCD cutter insert of FIG. 1 showing the microstructure of the PCD material in the PCD cutter insert of FIG. 1 prior to treatment;

FIG. 3 is a schematic partial cross-sectional view of an example of a system for vapour leaching PCD cutter elements in accordance with the principles disclosed herein; and

FIG. 4 is a schematic flow chart illustrating an example of a method for leaching a PCD cutter element in accordance with the principles disclosed herein.

The same reference numbers refer to the same respective features in all drawings.

### DESCRIPTION

The instant disclosure is directed to methods of processing superabrasive articles, such as superabrasive cutting elements, superabrasive bearings, and superabrasive discs. The superabrasive articles disclosed herein may be used in a variety of applications, such as drilling tools (e.g. compacts, cutting elements, gage trimmers, etc.), machining equipment, bearing apparatuses, wire-drawing machinery, and other apparatuses.

As used herein, a “superhard material” also known as a “superabrasive” material is a material having a Vickers hardness of at least about 28 GPa. Diamond and cubic boron nitride (cBN) materials are examples of superhard or superabrasive materials.

As used herein, a “superhard construction” or “superabrasive construction” means a construction or compact comprising a body of polycrystalline superhard or superabrasive material. In such a construction, a substrate may be attached thereto or alternatively the body of polycrystalline material may be free-standing and unbacked.

As used herein, polycrystalline diamond (PCD) is a type of polycrystalline superhard (PCS) material comprising a mass of diamond grains, a substantial portion of which are directly inter-bonded with each other and in which the content of diamond is at least about 80 volume percent of the material. In one example of PCD material, interstices between the diamond grains may be at least partly filled with a binder material comprising a solvent catalyst for diamond. As used herein, “interstices” or “interstitial regions” are regions between the diamond grains of PCD material. In examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate.

As used herein, the term “integrally formed” regions or parts are produced contiguous with each other and are not separated by a different kind of material.

The term “molar concentration” as used herein, may refer to a concentration in units of mol/L at a temperature of approximately 25[deg.] C. For example, a solution comprising solute A at a molar concentration of 1 M may comprise 1 mol of solute A per litre of solution.

As used herein, the term “depth of leaching” or “leach depth” refers to the distance into the PCD cutter element, from the outer surface thereof, to which the leaching acid has penetrated during the leaching process to remove residual solvent catalyst therefrom.

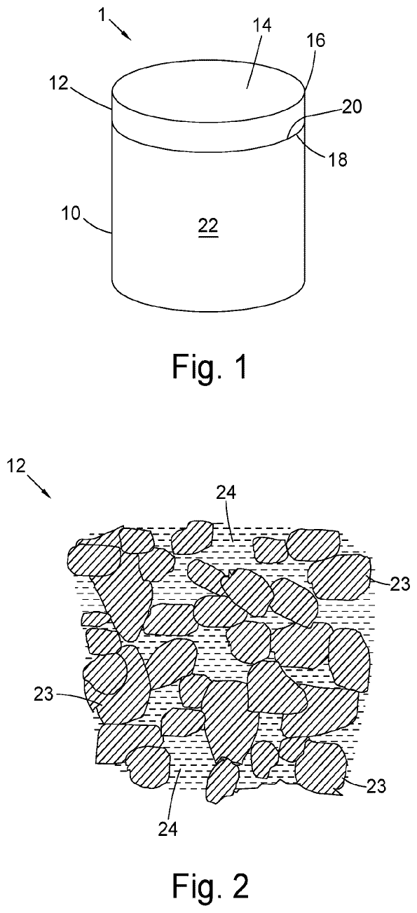

In an example as shown in FIG. 1, a cutting element 1 includes a substrate 10 with a body of PCD material 12 in the form of a layer formed on the substrate 10. The substrate 10 may be formed of a hard material such as cemented tungsten carbide. The cutting element 1 may be mounted into a bit body such as a drag bit body (not shown) and may be suitable, for example, for use as a cutter insert for a drill bit for boring into the earth.

The exposed top surface of the superhard material opposite the substrate forms the cutting face 14, which is the surface which, along with its edge 16, performs the cutting in use.

At one end of the substrate 10 is an interface surface 18 that forms an interface with the body of PCD material 12 which is attached thereto at this interface surface. As shown in the example of FIG. 1, the substrate 10 is generally cylindrical and has a peripheral surface 22 and a peripheral top edge 20.

As used herein, a PCD grade is a PCD material characterized in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material and said diamond grains may be natural or synthesized diamond grains.

Different PCD grades may have different microstructures and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

All of the PCD grades may comprise interstitial regions filled with material comprising cobalt metal, which is an example of solvent catalyst material for diamond.

The PCD structure 12 may comprise one or more PCD grades.

FIG. 2 is a cross-section through a body of PCD material which may form the super hard layer 12 of FIG. 1 in an example cutter element 1. During formation of a conventional polycrystalline diamond construction, the diamond grains 23 are directly interbonded to adjacent grains and the interstices 24 between the diamond grains 23 may be at least partly filled with a non-super hard phase material. This non-super hard phase material, also known as a filler material, may comprise residual solvent catalyst material, for example cobalt, nickel or iron.

In accordance with some examples of the method, a sintered body of PCD material 12 is created having diamond to diamond bonding and having a second phase comprising solvent catalyst material dispersed through at least a portion of its microstructure. The body of PCD material 12 and attached substrate 10 which form the cutter element 1 may be formed according to standard methods, using HPHT conditions to produce a sintered compact. For example, a PCD layer 12 may formed by subjecting a plurality of diamond particles (e.g. diamond particles having an average particle size between approximately 0.5 μm and approximately 150 μm) to an HPHT sintering process in the presence of a metal solvent catalyst, such as cobalt, nickel, iron, and/or any other suitable group VIII element. During the HPHT sintering process, adjacent diamond grains in a mass of diamond particles may become bonded to one another, forming a PCD table (body of PCD material 12) comprising interbonded diamond grains. In one example, diamond grains in table 12 may have an average grain size of approximately 20 μm or less. Additionally, during an HPHT sintering process, diamond grains may become bonded to the adjacent substrate 10 at the interface 18.

In various examples, the substrate 10 is formed of a cemented tungsten carbide material and after sintering, the resulting body of PCD material 12 may include tungsten and/or tungsten carbide in addition to the diamond grains and residual solvent catalyst material. For example, tungsten and/or tungsten carbide may be swept into the PCD layer 12 from the substrate 10 during HPHT sintering as liquefied solvent catalyst from the substrate 10 (e.g. cobalt from a cobalt-cemented tungsten carbide substrate) may dissolve and/or carry tungsten and/or tungsten carbide from the substrate 10 into the mass of diamond particles used to form the PCD table 12 during the HPHT sintering. In additional examples, tungsten and/or tungsten carbide particles may be intentionally mixed with diamond particles prior to forming the body of PCD material 12.

It has been found that the removal of non-binder phase from within the PCD table, conventionally referred to as leaching, is desirable in various applications. One reason for this is that the presence of residual solvent catalyst material in the microstructural interstices is believed to have a detrimental effect on the performance of PCD compacts at high temperatures as it is believed that the presence of the solvent catalyst in the diamond table reduces the thermal stability of the diamond table at these elevated temperatures.

To improve the performance and heat resistance of a surface region of the body of PCD material 12, at least a portion of the metal-solvent catalyst, such as cobalt, is to be removed from the interstices 24 of at least a portion of the body of PCD material 12. Additionally, in some examples, tungsten and/or tungsten carbide may be removed from at least a portion of the body of PCD material 12.

Chemical leaching is typically used to remove residual solvent catalyst from the body of PCD material 12 either up to a desired depth from an external surface of the body of PCD material or from substantially all of the PCD material 12. Following leaching, the body of PCD material 12 may therefore comprise a first volume that is substantially free of solvent catalyst material. However, small amounts of solvent catalyst material may remain within interstices that are inaccessible to the leaching process. Additionally, following leaching, the body of PCD material 12 may also comprise a volume or region that contains solvent catalyst material. In some examples, this further volume may be remote from one or more exposed surfaces of the body of PCD material 12.

The interstitial material which may include, for example, the metal solvent catalyst and one or more additions in the form of carbide additions, may be leached from the interstices 24 in the body of PCD material 12 by exposing the PCD material to an example leaching mixture for example in liquid or vapour form.

The PCD region 12 of the PCD compacts 1 to be leached by examples of the method typically, but not exclusively, may have a thickness of about 1.5 mm to about 4 mm.

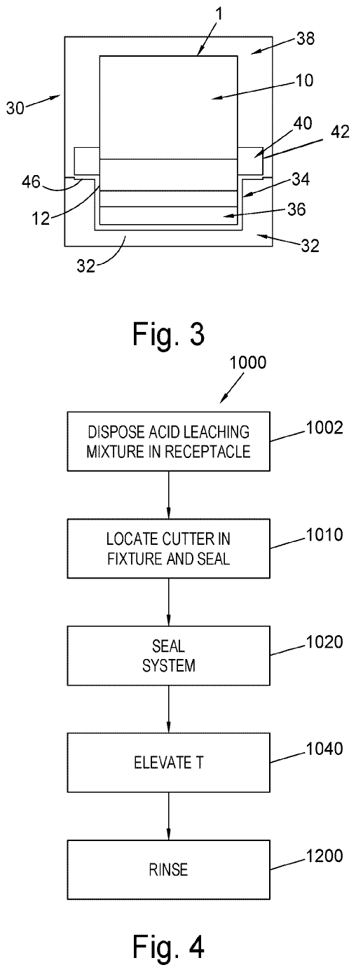

FIG. 3 is a schematic partial cross-sectional view of an example of a system 30 for vapour leaching a PCD cutter element 1 in accordance with the principles disclosed herein. The system 30 includes a leaching receptacle 32 into which a liner 34 may be located in some examples which may be acid resistant to protect the interior of the leaching receptacle 32 from the leaching acid mixture disposed within the receptacle. In general, the liner 34 may be made of any material suitable for use with leaching acid mixtures over extended periods of time at the relatively high temperatures experienced during the leaching process described in more detail below. Examples of suitable materials for the liner 34 may include, without limitation, fluropolymers such as PTFE.

A volume of liquid acid leaching mixture 36 is inserted into the leaching receptacle 32. In some examples, the volume is between around 5% to around 80% of the interior volume of the leaching receptacle 32. In other examples the volume is around 50% of the interior of the leaching receptacle 32.

The PCD cutter element 1 is attached to a fixture 38. A seal member 40 is applied around the peripheral side edge of the cutter element 1 leaving a portion of the surface of the body of PCD material 12 of the cutter element exposed. The fixture 38 with the PCD cutter element 1 attached is located in the leaching receptacle 32 to suspend the PCD cutter element 1 above the acid leaching mixture 36 and spaced therefrom. The leaching receptacle 32 is sealed to the top fixture 38 thereby providing a closed system. In some examples, a threaded connection or other mechanical locking mechanism may be used to connect the top fixture 38 to the leaching receptacle 32 to close the system 30. A threaded coupling or connection may have the advantage of providing an evenly distributed load during the assembly process and throughout the leaching cycle. However, alternative mechanical mechanisms may be used such as a clamping or bolted mechanism.

To treat the PCD cutter element to leach residual solvent catalyst from at least a portion thereof the system 30 is heated to above ambient conditions, such as to around between 100 to around 300 degrees C to transition at least some of the liquid acid leaching mixture to acid vapour(s). In some examples, the temperature is between around 140 to around 200 degrees C and in others t is between around 145 to around 180 degrees C. The exposed surface of the body 12 of PCD material of the PCD cutter element 1 is spaced from the acid leaching mixture and is exposed to the acid vapour(s) which leach the non-diamond phase constituents from the body 12 of PCD material.

In some examples the seal member 40 around the PCD cutter element is an o-ring seal extending around the PCD cutter element to protect the substrate 10 from the acid vapour(s). Such a seal member 40 may provide both mechanical and chemical protection of the unexposed parts of the PCD cutter element from the acid vapours and may be used also to control the form of leach profile obtained in the body of PCD material 12. Example materials which may be suitable for forming the seal member 40 may include a fluroelastomer such as a fluorinated, carbon-based rubber (including for example a Viton™ o-ring which is a VI780 grade of FKM). Other examples include but are not limited to those made of perfluoroelastomeric compounds (FFKM).

As shown in FIG. 3, in the closed system configuration, the seal member 40 is disposed in a mating annular groove 42 proximate the free open end of the fixture 38, to form an annular seal around the peripheral outer side surface of the body of PCD material 12. The seal member 40 also contacts the leaching receptacle 32 at the join with the fixture 38 to provide an additional sealing mechanism to the system 30 in the assembled configuration.

Also as shown in the example of FIG. 3, the fixture 38 suspends the PCD cutter element 1 above the acid leaching mixture 36, the PCD material 12 of the cutter element 1 facing the acid leaching mixture 36 but being spaced therefrom.

Suitable acid leaching mixtures 36 for use in the system 30 may include, for example, an acid leaching mixture comprising any one or more of hydrochloric (HCl) acid, hydrofluoric (HF) acid, nitric (HNO₃) acid, sulfuric (H₂SO₄) acid, and/or phosphoric (H₃PO₄) acid at a molar concentration of between around 4M to around 9M and water. In some examples the acid leaching mixture 36 may comprise hydrofluoric acid at a molar concentration of between around 4M to around 9M, nitric acid at a molar concentration of between around 4M to around 9M, and water. In still further examples, an acid leaching mixture 36 comprising hydrofluoric acid at a molar concentration of between around 5 M to around 7M, nitric acid at a molar concentration of between around 6.7M to around 8M and water may be used. The water may be de-ionized water. In some examples, the hydrofluoric acid comprises between around 10 vol % to around 30 vol % of the acid mixture, the nitric acid or other acid(s) comprises between around 30 vol % to around 60 vol % of the acid mixture, and the water forms between around 20 to around 50 vol% of the mixture.

One or both of the fixture 38 and leaching receptacle 32 may be formed, for example, of stainless steel or may be made out of any suitable material capable of withstanding the high temperatures within the leaching receptacle 32 during the leaching process described in more detail below.

FIG. 4 is a flow diagram of an exemplary method 1000 for processing a body of PCD material 12. The method 1000 will be described as being performed with the system 30 previously described, however, it should be appreciated that the method 1000 may be performed with other suitable vessel(s) while still complying with the principles disclosed herein. As illustrated in this figure, and as indicated at 1002, a liquid acid mixture (e.g. acid 36) is disposed within a leaching receptacle 32 to a level below the open end 46 thereof. The acid leaching mixture may be any suitable acid for leaching a body of PCD material including, without limitation, any of the leaching acid mixtures previously described. At stage 1010, a PCD cutter element 1 is located in a fixture 38 and a seal member 40 is positioned around a portion of the outer peripheral side surface of the body of PCD material to be leached. Stage 1010 may occur before or after stage 1002. In stage 1020, the system 30 is then sealed by attaching the fixture 38 holding the PCD cutter element 1 to the leaching receptacle 32 through the threaded connection of this example, resulting in partial compression of the seal member 40 to further seal the system 30. In the closed configuration, the cutter element 1 is suspended within the leaching receptacle 32 above the liquid acid mixture 36 and spaced therefrom such the cutter element 1 does not contact the liquid acid mixture. The temperature within the leaching receptacle 32 is elevated in stage 1040 such that at least a portion of the acid mixture 36 begins to vaporize and leach the body of PCD material of the cutter element 1. The substrate 10 of the cutter element is protected from the leaching acid vapour(s) by the seal member 40 or other suitable means.

In stage 1040 of method 1000, the elevated temperature within the leaching receptacle 32 is maintained for a period of time to enable leaching of the body of PCD material to the desired leach depth to be achieved. As shown in FIG. 3, such the body of PCD material to be leached is at least partially exposed and suspended above acid leaching mixture 36. Thus, the cutter element 1 does not directly contact the liquid acid mixture 36 during the leaching process of stage 1040.

In stage 1040, the temperature of the system 30 is increased to begin transitioning the acid leaching mixture 36 from a liquid to a vapour in the leaching receptacle 32. The temperature may be increased using any suitable technique or device known in the art. For example, a heat generating component may be coupled to or be placed in contact with the outer surface of the leaching chamber 32 such that heat generated by the heat generating component may increase the temperature within leaching receptacle 32. The temperature of the leaching receptacle 32 during the leaching process may be for example between around 100 to around 300 °C.

During stage 1040, the acid vapour(s) of the acid leaching mixture acid in the leaching receptacle 32 come into contact with the exposed body of PCD material 12 of the PCD cutter element 1 held within the fixture 38, but is/are restricted and/or prevented from contacting the substrate 10 via the sealing member 40. Heating the leaching receptacle 32 and/or directly heating the acid leaching mixture 36 therein, and holding the acid leaching mixture 36 at a selected temperature during the leaching process may be advantageous as it is believed to assist in maintaining the integrity of the seal member 40.

After exposure to the acid leaching mixture for the desired time, the body of PCD material is rinsed to remove residual acid leaching mixture therefrom, as illustrated in step 1200 in FIG. 4. The rinsing step may include cooling the leaching receptacle after the step of exposing the PCD cutter element to the acid vapour(s) to leach the PCD cutter element, removing residual acid leach mixture from the leaching receptacle then rinsing with, for example de-ionised water to remove residual acid leaching mixture from the PCD cutter element 1. The rinsing step may include introducing de-ionised water into the leaching receptacle, sealing the leaching receptacle in the same manner as for the leaching process and elevating the temperature of the leaching receptable and/or water therein for a period of time to vaporise the water and rinse the PCD material. The rinsing step may be repeated with fresh water a number of times as desired or necessary. The necessity of this may be determined by testing the pH of the discarded water to determine its acidity. Multiple rinsing cycles may be needed to achieve a pH of 5 or above, which means that the sample is safe to handle (with PPE) before drying at, for example, between around 60 to around 90 degrees C for several hours.

Some versions are described in more detail with reference to the following examples which are not intended to be limiting. The following examples provide further detail in connection with the examples described above.

### Example 1

Cutting elements, each comprising a body of PCD material 12 attached to a tungsten carbide substrate 10, were formed by HPHT sintering of diamond particles in the presence of cobalt. The sintered bodies of PCD material included cobalt within the interstitial regions between the inter-bonded diamond grains. Each body of PCD material 12 was leached using a leaching mixture including 44 vol % 6.7M nitric acid, 18 vol % 5M hydrofluoric acid and 38 vol% deionized water. The processing technique used was a vapour leaching technique in which the cutters were placed in individual leaching chambers and suspended above an amount of the example acid leaching mixture, the mixture filling around 50% of the volume of the leaching chamber. The chamber was sealed and heated to a temperature of around 180 degrees C to vaporize at least a portion of the acid leaching mixture. The bodies of PCD materials were leached by the acid vapour for 100 hours. At this time the leach depth of the body of PCD material was determined for various portions of the PCD table, through x-ray analysis. It was found that an average leach depth of between around 800 to around 1541 microns had been achieved after 100 hours. This is in contrast to an equivalent cutting element formed of an identical PCD table attached to a tungsten carbide substrate leached according to a conventional leaching mixture using conventional aqueous leaching techniques in which the body of PCD material to be leached is immersed in part in a conventional acid leaching mixture comprising hydrofluroric acid (HF) and nitric acid (HNO₃) diluted in water HF:HNO₃ (1:3) and heated to between around 40-70 degrees C for around 100 hours to leach the PCD material and, using such a technique, the bodies of PCD material so leached were found to have an average leach depth of around 345 microns after 100 hours.

### Example 2

Cutting elements, each comprising a body of PCD material 12 attached to a tungsten carbide substrate 10, were formed by HPHT sintering of diamond particles in the presence of cobalt. The sintered bodies of PCD material included cobalt within the interstitial regions between the inter-bonded diamond grains. Each body of PCD material 12 was leached using a leaching mixture including 44 vol % 6.7M nitric acid, 18 vol % 5M hydrofluoric acid and 38 vol % deionized water. The processing technique used was a vapour leaching technique in which the cutters were placed in individual leaching chambers and suspended above an amount of the example acid leaching mixture, the mixture filling around 50% of the volume of the leaching chamber. The chamber was sealed and heated to a temperature of around 200 degrees C to vaporize at least some of the acid leaching mixture. The bodies of PCD materials were leached by the acid vapour for 100 hours. At this time the leach depth of the body of PCD material was determined for various portions of the PCD table, through x-ray analysis. It was found that an average leach depth of between around 800 to around 1133 microns had been achieved after 100 hours.

### Example 3

Cutting elements, each comprising a body of PCD material 12 attached to a tungsten carbide substrate 10, were formed by HPHT sintering of diamond particles in the presence of cobalt. The sintered bodies of PCD material included cobalt within the interstitial regions between the inter-bonded diamond grains. Each body of PCD material 12 was leached using a leaching mixture including around 44 vol % 6.7M nitric acid, around 18 vol % 5M hydrofluoric acid and around 38 vol % deionized water. The processing technique used was a vapour leaching technique in which the cutters were placed in individual leaching chambers and suspended above an amount of the example acid leaching mixture, the mixture filling around 50% of the volume of the leaching chamber. The chamber was sealed and heated to a temperature of around 200 degrees C to vaporize at least some of the acid leaching mixture. The bodies of PCD materials were leached by the acid vapour for 100 hours. At this time the leach depth of the body of PCD material was determined for various portions of the PCD table, through x-ray analysis. It was found that an average leach depth of around 1023 microns had been achieved after 100 hours.

### Example 4

The same technique as described above in Examples 1 to 3 was applied to leach PCD cutters using each having a body of PCD material 12 to be leached, but in this example a leaching mixture including around 30-60 vol % 7.5M nitric acid, around 10-30 vol % 6.7M hydrofluoric acid and the remainder vol % being deionized water was used. The bodies of PCD materials were leached by the acid vapour for 100 hours. At this time the leach depth of the body of PCD material was determined for various portions of the PCD table, through x-ray analysis. It was found that an average leach depth of around 1029 microns had been achieved after 100 hours.

### Example 5

The same technique as described above in Examples 1 to 3 was applied to leach PCD cutters using each having a body of PCD material 12 to be leached, but in this example a leaching mixture including around 40-50 vol % 8.5M nitric acid, around 10-20 vol % 8M hydrofluoric acid and the remainder vol % being deionized water was used. The bodies of PCD materials were leached by the acid vapour for 100 hours. At this time the leach depth of the body of PCD material was determined for various portions of the PCD table, through x-ray analysis. It was found that an average leach depth of around 894 microns had been achieved after 100 hours.

### Example 6

The same technique as described above in Examples 1 to 3 was applied to leach PCD cutters using each having a body of PCD material 12 to be leached, but in this example a leaching mixture including around 30-60 vol % 9.2M nitric acid, around 10-30 vol % 9.6M hydrofluoric acid and the remainder vol % being deionized water was used. The bodies of PCD materials were leached by the acid vapour for 100 hours. At this time the leach depth of the body of PCD material was determined for various portions of the PCD table, through x-ray analysis. It was found that an average leach depth of around 762 microns had been achieved after 100 hours.

### Example 7

The same technique as described above in Examples 1 to 3 was applied to leach PCD cutters using each having a body of PCD material 12 to be leached, but in this example a leaching mixture including around 30-60 vol % 6.9M nitric acid, around 10-30 vol % 9.6M hydrofluoric acid and the remainder vol % being around 10-50 vol % deionized water was used. The bodies of PCD materials were leached by the acid vapour for 100 hours. At this time the leach depth of the body of PCD material was determined for various portions of the PCD table, through x-ray analysis. It was found that an average leach depth of around 824 microns had been achieved after 100 hours.

When compared with the leach depths achievable using conventional leaching solutions, such as a mixture of HCl and water, or hydrofluroric acid (HF) and nitric acid diluted in water (HF:HNO₃ (1:3)) it has been determined that the examples including the above leaching mixtures may enable a greater leaching efficiency to be achieved with greater leach depths being achievable in a shorter period of time, in some cases enabling the desired leach depth to be achieved around 4 to around 6 times faster than using conventional acid leaching mixtures and processing techniques.

A further important consideration in the system 30 and method of leaching the body of PCD described herein is a health and safety aspect, in addition to providing a system with increased leaching rates over conventional liquid leaching techniques. It is believed that there is a risk of a system exploding if an inappropriate amount of acid leaching mixture be used. It was found that a fill volume of acid leaching mixture of between around 5% to around 80% of the volume of the leaching receptacle and, in some examples, around 50% provided both an accelerated leaching rate compared to conventional aqueous acid leaching techniques in an acid bath, whilst assisting in potentially reducing the health and safety risks associated with such potentially dangerous acids. It has been appreciated that over pressurisation in the leaching receptacle may arise if the volume of acid leaching mixture is too great. In the case of an underfill, a reduction in leaching rate or cessation of leaching may occur due to the reduced availability of reactants. The other factor to consider are the by-products of the reactions during the leaching process which, in the case of an HF/HNO₃ acid leaching mixture of the nature described herein, are NOx vapours and, in addition to the generated reaction vapour, these may increase the internal vapour pressure during the leaching process. Whilst not wishing to be bound by any particular theory, it could be postulated that as an increasing amount of NOx is generated it could push the pressure equilibrium to force more of the reagent vapour into the liquid phase thereby slowing the leach rate.

The preceding description has been provided to enable others skilled the art to best utilize various aspects described by way of example herein. This description is not intended to be exhaustive or to be limited to any precise form disclosed. Many modifications and variations are possible. In particular, some example methods may be equally applicable to the effective leaching of PCD with other additives or interstitial material such as those in the form of other metal carbides including one or more of a carbide of tungsten, titanium, niobium, tantalum, zirconium, molybdenum, vanadium or chromium.

1. A method for leaching a polycrystalline diamond (PCD) cutter element having a non-diamond phase comprising a solvent catalyst material, the method comprising:
(a) providing a leaching receptacle having an interior volume;
(b) introducing a volume of liquid acid leaching mixture into the leaching receptacle, the volume being between around 5% to around 80% of the interior volume of the leaching receptacle;
(c) attaching the PCD cutter element to a fixture;
(d) applying a seal member around the PCD cutter element;
(d) locating the fixture with the PCD cutter element attached in the leaching receptacle to suspend the PCD cutter element above the acid leaching mixture;
(e) sealing the leaching receptacle to provide a closed system;
(f) elevating the temperature of the liquid acid leaching mixture to above ambient conditions to transition at least some of the liquid acid leaching mixture to acid vapour(s); and
(g) exposing the PCD cutter element to the acid vapour(s) to leach the PCD cutter element.

2. The method of claim 1, wherein the volume of acid leaching mixture comprises between around 30% to around 60% of the interior volume of the leaching receptacle.

3. The method of claim 1, wherein the volume of acid leaching mixture comprises between around 40% to around 50% of the interior volume of the leaching receptacle.

4. The method of claim 1, wherein the step of elevating the temperature of the liquid acid leaching mixture to above ambient conditions to transition at least some of the liquid acid leaching mixture to acid vapour(s) comprises heating the leaching mixture to between around 100 degrees C to around 300 degrees C.

5. The method of claim 1, wherein the step of applying a seal member around the PCD cutter element comprises applying an o-ring seal around the PCD cutter element to protect the substrate from the acid vapour(s).

6. The method of claim 1, wherein the step of locating the fixture comprises locating the fixture to suspend the PCD cutter element above the acid leaching mixture, the PCD material of the cutter element facing the acid leaching mixture but being spaced therefrom.

7. The method of claim 1, wherein the step of introducing a volume of liquid acid leaching mixture into the leaching receptacle comprises introducing an acid leaching mixture at a molar concentration of between around 4M to around 9M comprising any one or more of hydrochloric (HCl) acid, hydrofluoric (HF) acid, nitric (HNO₃) acid, sulfuric (H₂SO₄) acid, and/or phosphoric (H₃PO₄) acid; and water.

8. The method of claim 1, wherein the step of introducing a volume of liquid acid leaching mixture into the leaching receptacle comprises introducing an acid leaching mixture comprising hydrofluoric acid at a molar concentration of between around 4M to around 9M; nitric acid at a molar concentration of between around 4M to around 9M; and water.

9. The method of claim 1, wherein the step of introducing a volume of liquid acid leaching mixture into the leaching receptacle comprises introducing an acid leaching mixture comprising hydrofluoric acid at a molar concentration of between around 5 M to around 7M; and nitric acid at a molar concentration of between around 6.7M to around 8M; and water.

10. The method of claim 7. wherein the water comprises de-ionized water.

11. The method of claim 1, wherein the step of sealing comprises sealing the fixture holding the PCD cutter element to the leaching receptacle.

12. The method of claim 1, wherein the step of elevating the temperature of the liquid acid leaching mixture comprises heating the leaching receptacle and/or directly heating the acid leaching mixture therein, and holding the acid leaching mixture at a selected temperature during the leaching process.

13. The method of claim 1, further comprising cooling the leaching receptacle after the step of exposing the PCD cutter element to the acid vapour(s) to leach the PCD cutter element.

14. The method of claim 13, further comprising removing residual acid leach mixture from the leaching receptacle.

15. The method of claim 14, further comprising rinsing the PCD cutter element to remove residual acid leaching mixture therefrom.

16. The method of claim 15, wherein the step of rinsing comprising introducing de-ionised water into the leaching receptacle and elevating the temperature of the leaching receptable and/or water therein to vaporise the water.

17. The method of claim 1, wherein the step of elevating the temperature of the liquid acid leaching mixture to above ambient conditions to transition at least some of the liquid acid leaching mixture to acid vapour(s) comprises heating the leaching mixture to between around 140 degrees C to around 200 degrees C.

18. The method of claim 1, wherein the step of elevating the temperature of the liquid acid leaching mixture to above ambient conditions to transition at least some of the liquid acid leaching mixture to acid vapour(s) comprises heating the leaching mixture to between around 145 degrees C to around 180 degrees C.

19. A polycrystalline diamond construction treated according to claim 1 to remove solvent catalyst material from at least a portion of interstitial spaces between interbonded diamond grains.
